(19) United States
(12) Patent Application Publication
(10) Pub. No.: US 2008/0133347 A1
(43) Pub. Date: Jun. 5, 2008

(54) System and method for providing semantic captchas for online advertising

(75) Inventors: Vanja Josifovski, Los Gatos, CA (US); David M. Pennock, Monroe Township, NJ (US); Shanmugasundaram Ravikumar, Cupertino, CA (US); Benjamin Clay Reed, Morgan Hill, CA (US); Andrew Tomkins, San Jose, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/607,596

(22) Filed: Dec. 1, 2006

(51) Int. Cl. G06Q 30/00

(52) U.S. Cl. 705/14

(57) ABSTRACT

An improved system and method for providing and using captchas for online advertising is provided. An advertisement may be received, embedded in a captcha and stored for use in online advertising. A question about the advertisement may also be stored along with a valid answer for use in verifying a user has received an impression of the advertisement. In response to a request received for sending a captcha with an embedded advertisement to a web browser operating on a client, a captcha with an embedded advertisement may be selected and sent to the web browser for display as part of a web page. Upon verifying the response to the question from the user is a valid answer, receipt of an impression of the advertisement may be recorded. Additionally, the awareness of an online advertisement may be measured for a target audience and reported to advertisers.

### CROSS-REFERENCE TO RELATED APPLICATIONS

The present invention is related to the following United States patent application, filed concurrently herewith and incorporated herein in its entirety:

“System and Method for Measuring Awareness of Online Advertising Using Captchas,” Attorney Docket No. 1320; and

“System and Method for Delivering Online Advertisements Using Captchas,” Attorney Docket No. 1350.

### FIELD OF THE INVENTION

The invention relates generally to computer systems, and more particularly to an improved system and method for providing and using captchas for online advertising.

### BACKGROUND OF THE INVENTION

Online advertising systems that may offer to sell a customer's products online may provide an infrastructure for completing a sales transaction. A user presented with the ad may click the ad in order to be taken to a web page provided by the advertiser to complete a sales transaction. Typically, the advertiser pays by the click, and, in order to measure the effectiveness of the ad, must track the users who arrive at the provided web page to determine how many go on to complete the transaction. This tracking is well within the capabilities of sophisticated advertisers.

However, online advertising systems lack the infrastructure to measure awareness of online “brand” or “awareness” advertising. Advertisers often use media ads in order to perform “brand” or “awareness” advertising with the goal of increasing the awareness of the advertiser or of a certain product or brand among users from a certain group. Unlike the pay-per-click model applied to advertising to sell a customer's products online, media ads used to perform “brand” or “awareness” advertising are typically paid for by impression; that is, a fee is paid whenever the ad is shown. This pricing model is natural given that the goal of the advertiser is to improve awareness. The advertiser wishes for users to see the ad, and the advertiser hopes that, over time, users from a particular group will have increased awareness of the brand as a result of the brand advertising campaign.

Unfortunately, current online advertising systems performing brand advertising not only fail to provide a way to measure the effectiveness of advertising, many systems fail to verify that a human has received an advertisement, rather than an online agent for instance. Because a user need not express any interest in the advertisement to generate a charge to the advertiser, few systems attempt to verify that a human has received an advertisement. Some systems may employ banner ads that verify that a user has clicked on a particular location to verify the presence of a person. These banner ads are usually in the form of a game, such as bugs animated in the banner ad to appear running around that a user may click on to signify the presence of a person. However, such techniques fail to measure any awareness of the advertiser or of a certain product or brand of the advertiser.

As a result, it difficult to infer the return on investment of an online brand advertising campaign. Due to the uncertainty of the return on investment, advertisers may place a lower value on online brand advertising than they might otherwise. What is needed is an online advertising system and method that may measure awareness of online brand advertising. Such a system and method should be able to verify that a user has received an online brand advertisement.

### SUMMARY OF THE INVENTION

Briefly, the present invention may provide a system and method for providing and using captchas for online advertising. A captcha advertising server may provide services for providing and using captchas for online advertising, including services for sending a captcha with an embedded advertisement to a web browser operating on a client. In various embodiments, a captcha advertising server may include an operably coupled captcha generator for creating a captcha with an embedded advertisement and, in some embodiments, one or more questions about the embedded advertisement. The captcha advertising server may also include an operably coupled captcha selector for selecting a captcha with an embedded advertisement for display, for instance, by a web browser as part of a web page. The captcha advertising server may further include an operably coupled response validator for verifying that a response to a question about the advertisement embedded in the captcha may be valid. Additionally, the captcha advertising server may include an operably coupled measurement comparator for measuring awareness of online advertising by target audiences.

The present invention may provide a framework for providing and using captchas for online advertising. An advertisement may be received, embedded in a captcha and stored for use in online advertising. A question about the advertisement may also be stored along with a valid answer for use in verifying a user has received an impression of the advertisement. In various embodiments, the question may also be embedded in the captcha with the embedded advertisement. In response to a request received for sending a captcha with an embedded advertisement to a web browser operating on a client, a captcha with an embedded advertisement may be selected and sent to the web browser for display as part of a web page. And the user may be prompted to input a response to a question about the embedded advertisement. Upon verifying the response to the question from the user is a valid answer, receipt of an impression of the advertisement may be recorded.

Additionally, the framework of the present invention may be used to measure the awareness of an online advertisement for a target audience. In response to individual requests received from a subset of members of a target audience for sending a captcha with an embedded advertisement, a captcha with an embedded advertisement may be selected and sent to the subset of members of the target audience in response to their individual requests for display as part of a web page. The subset of members of the target audience may be prompted to input a response to a question about the embedded advertisement to measure awareness of the embedded advertisement and the receipt of an impression may be recorded for valid responses from the subset of members of the target audience. Another subset of members of the target audience not sent the captcha with the embedded advertisement may be prompted to input a response to a question about the embedded advertisement to measure awareness of the embedded advertisement and the receipt of an impression may be recorded for valid responses from this subset of members of the target audience who were not sent the captcha with the embedded advertisement. The measurements of awareness for the two subsets of the target audience may be compared, and the difference may be reported to an advertiser in various embodiments as a measure of effectiveness of an online advertising campaign.

Advantageously, the present invention may effectively measure the impact of an online advertising campaign on brand awareness over time. In an embodiment, measurements of an online advertising campaign may be periodically reported to advertisers to provide a view of the effectiveness of the online advertising campaign on brand awareness over time. Moreover, measurements of a particular advertising campaign may be compared to measurements of another advertising campaign for determining the effectiveness of a particular online advertising campaign. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for providing and using captchas for online advertising, in accordance with an aspect of the present invention;

FIG. 3 is an illustration depicting in an embodiment a captcha with an embedded advertisement and an embedded question about the advertisement, in accordance with an aspect of the present invention;

FIG. 4 is a flowchart for generally representing the steps undertaken in one embodiment for generating a captcha with an embedded advertisement, in accordance with an aspect of the present invention;

FIG. 5 is a flowchart for generally representing the steps undertaken in one embodiment for delivering an online advertisement using a captcha with an embedded advertisement, in accordance with an aspect of the present invention;

FIG. 6 is a flowchart for generally representing the steps undertaken in one embodiment for verifying receipt of an impression of an online advertisement delivered using a captcha with an embedded advertisement, in accordance with an aspect of the present invention;

FIG. 7 is a flowchart for generally representing the steps undertaken in one embodiment for measuring the awareness of an online advertisement delivered using a captcha with an embedded advertisement, in accordance with an aspect of the present invention;

FIG. 8 is a flowchart for generally representing the steps undertaken in one embodiment for delivering an online advertisement using a captcha with an embedded advertisement to a subset of a target audience, in accordance with an aspect of the present invention; and

FIG. 9 is a flowchart for generally representing the steps undertaken in one embodiment for verifying receipt of an impression of an online advertisement delivered using a captcha with an embedded advertisement to a subset of a target audience, in accordance with an aspect of the present invention.

### DETAILED DESCRIPTION

### Exemplary Operating Environment

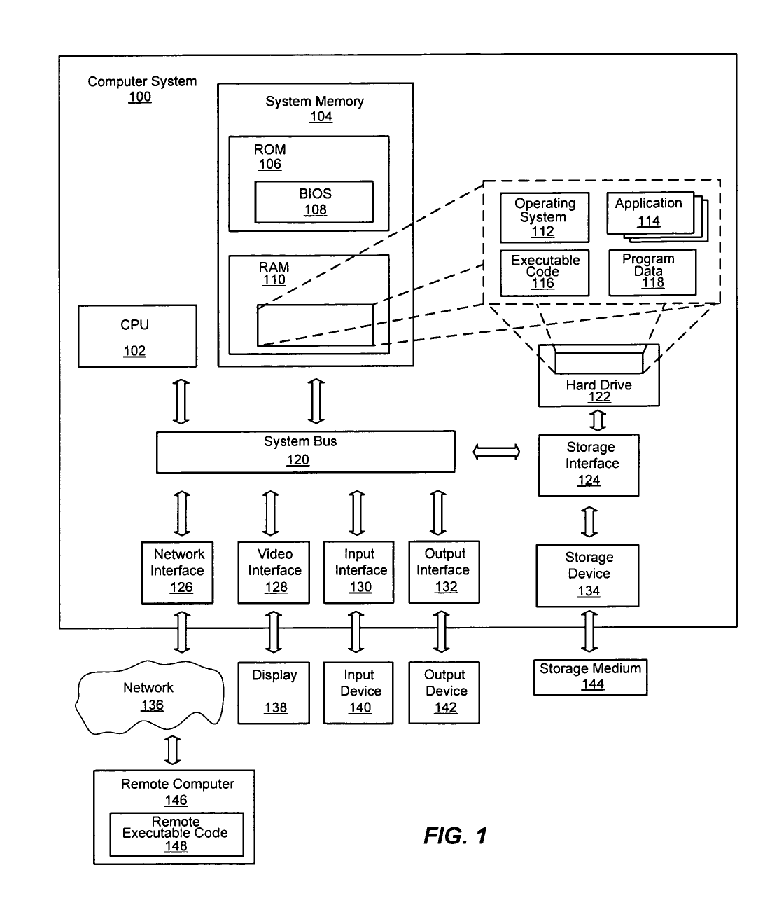

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Providing Semantic Captchas for Online Advertising

The present invention is generally directed towards a system and method for providing and using captchas for online advertising. A “captcha”, as used herein, may mean a graphic including an image of one or more words that are distorted in order to make it difficult for an automated agent or machine process to decipher, but easy for a human to decipher. Captchas are used to verify that a human may be involved in a transaction or communication rather than an automated agent. A captcha may usually take the form of an image of a word that is mangled in some way and may be used in transactions that may require a human present, such as signing up for an online account, for instance. In this case, a captcha may be displayed, and, as part of the transaction, the text of the captcha must be supplied as input by presumably a human being. Captchas may also be used to avoid certain types of spam. For example, when a user enters a comment into an online system, it is increasingly common for an online system to send a captcha in order to verify that an automated agent is not posting an advertising link automatically on a large number of comments in the online system.

The present invention provides and uses captchas to convey advertisements for online advertising by embedding a semantic message such as an advertisement or a brand awareness test in the graphic of a captcha. In addition to embedding an advertisement in a captcha, the present invention may also embed polls into captchas. For example, a captcha may be represented by a graphic with an embedded question: “Which of these is not an allergy medication: Claritin, Benadryl, Mybrand, and Aardvark?” In this example, awareness may be measured for the brand, Mybrand, and Aardvark may represent a scientific-sounding non-brand against which Mybrand may be competing in the study. The number of responses for all four possible answers may be measured and the awareness of aardvark may be compared to that of well-known brands.

As will be seen, the framework of the present invention may be used to verify that a user has received an online brand advertisement and may also be used to measure the awareness of an online advertisement for a target audience. As will be understood, the various block diagrams, flow charts and scenarios described herein are only examples, and there are many other scenarios to which the present invention will apply.

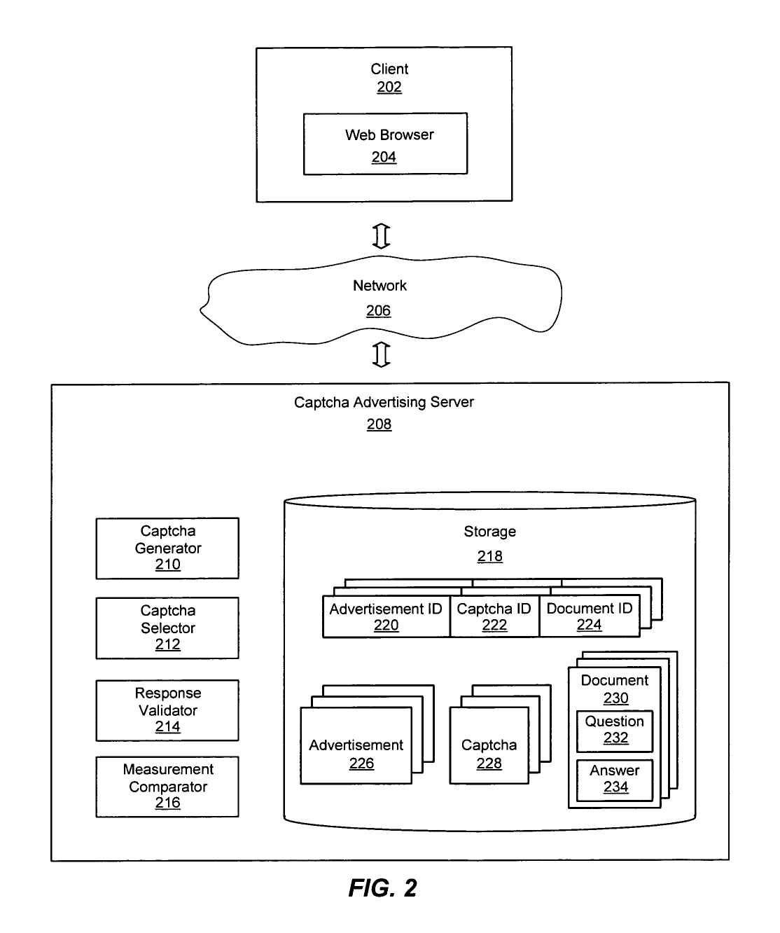

Turning to FIG. 2 of the drawings, there is shown a block diagram generally representing an exemplary architecture of system components for providing and using captchas for online advertising. Those skilled in the art will appreciate that the functionality implemented within the blocks illustrated in the diagram may be implemented as separate components or the functionality of several or all of the blocks may be implemented within a single component. For example, the functionality for the response validator 216 may be included in the same component as the measurement comparator 218. Moreover, those skilled in the art will appreciate that the functionality implemented within the blocks illustrated in the diagram may be executed on a single computer or distributed across a plurality of computers for execution.

In various embodiments, a client computer 202 may be operably coupled to one or more servers 208 by a network 206. The client computer 202 may be a computer such as computer system 100 of FIG. 1. The network 206 may be any type of network such as a local area network (LAN), a wide area network (WAN), or other type of network. A web browser 204 may execute on the client computer 202 and may include functionality for receiving a web page requested by a user. The web browser may send a request for a web page to a web page server. When a request may be received by a web page server to serve a web page, the web page server may determine that the web page requested may include a web page placement for a captcha. The web page server may then request a captcha from a captcha advertising server to send to a web browser operating on a client so that the captcha with an embedded advertisement may be displayed as part of the web page by the web browser 204. In various embodiments, a user may be requested to answer a question about the embedded advertisement when the captcha may be displayed. In an embodiment, the question may be sent along with the captcha to the web browser. In other embodiments, the captcha may also include an embedded question about the embedded advertisement. The web browser may send the response to the question to the captcha advertising server for verification. In general, the web browser 204 may be any type of interpreted or executable software code such as a kernel component, an application program, a script, a linked library, an object with methods, and so forth.

The captcha advertising server 208 may be any type of computer system or computing device such as computer system 100 of FIG. 1. In general, the captcha advertising server 208 may provide services for providing and using captchas for online advertising, including services for receiving a request to send a captcha with an embedded advertisement to a web browser operating on a client for display as part of a web page and services for sending the captcha with the embedded advertisement to the web browser. In various embodiments, the captcha advertising server 208 may also provide services for receiving responses from a target audience responding to a question about a captcha with an embedded advertisement displayed to the target audience as part of a web page. In particular, the captcha advertising server 208 may include a captcha generator 210 for creating a captcha with an embedded advertisement and, in various embodiments, one or more questions about the advertisement. The captcha advertising server 208 may also include a captcha selector 212 for selecting a captcha with an embedded advertisement for display, for instance, by a web browser as part of a web page. The captcha advertising server 208 may further include a response validator 214 for verifying that a response to a question about the advertisement embedded in the captcha may be valid. Additionally, the captcha advertising server 208 may include a measurement comparator 216 for measuring awareness of online advertising by target audiences. Each of these modules may also be any type of executable software code such as a kernel component, an application program, a linked library, an object with methods, or other type of executable software code.

The captcha advertising server 208 may be operably coupled to a database of information about captchas used for online advertising such as storage 218. Storage 218 may include advertisements 226 that may be embedded in captchas 228 and may have associated documents 230 that may include one or more questions 232 about an advertisement and answers 234 that may be valid responses to the questions. An advertisement ID 220 referencing an advertisement 226 may be associated with a captcha ID 222 referencing a captcha 228 that may include the advertisement 226 embedded in it, and the advertisement ID 220 and the captcha ID 222 may also be associated with a document ID 224 referencing a document 230 that may include one or more questions 232 about the advertisement 226 and answers 234 that may be valid responses to the questions. In various embodiments, the captcha 228 referenced by the captcha ID 222 may also include embedded in it one or more of the questions 232 about the advertisement 226 embedded in it. Any type of advertisements 226 may be embedded in a captcha 228.

In general, marketing personnel may generate marketing material, including advertisements, intended to convey a marketing message. The marketing material may take the form of a banner ad, a short video or audio clip, or other multi-media embodiment. The marketing personnel may also generate questions about the marketing material that may be used to validate the receipt of the intended marketing message. Typically, the answers to the questions may be input using a keyboard by an end user, but other forms of inputs may also be used such as clicking in a particular spot on the screen. Alternatively, the question may be embodied in a game and the answer may correspond to successful completion of the game.

When a captcha may be needed, an advertisement may be chosen as well as a corresponding question. The captcha and question may be presented to the user. When the user answers successfully, the captcha will allow a transaction to proceed and will report a successful receipt of the marketing message. Advertisers may then be billed according to the number of successfully received marketing messages.

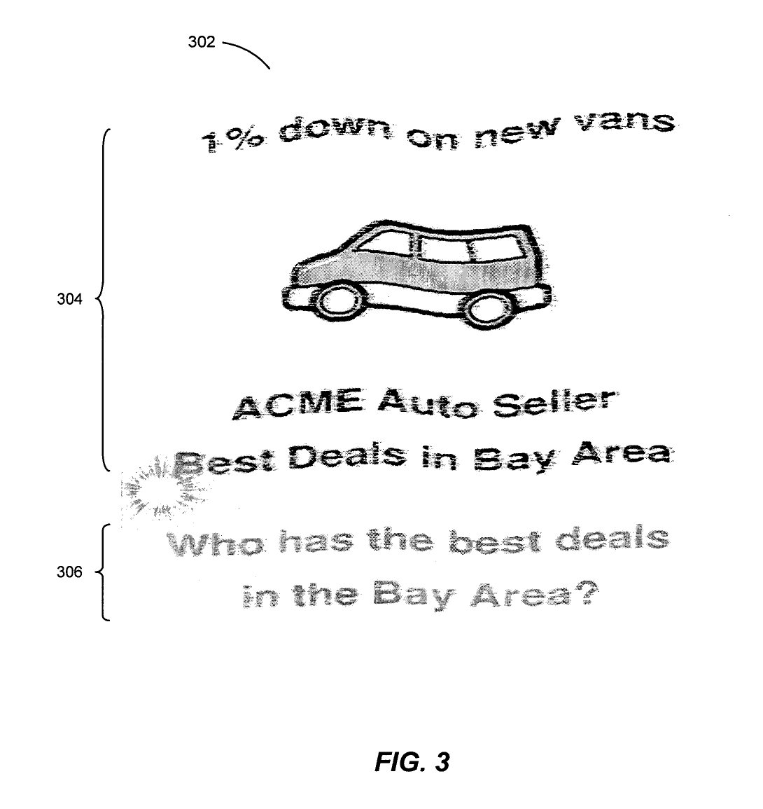

For instance, FIG. 3 presents an illustration depicting in an embodiment a captcha with an embedded advertisement and an embedded question about the advertisement. A web browser may display the captcha 302 as part of a web page. In the embodiment illustrated in FIG. 3 for example, a captcha 302 may include an advertisement 304 embedded in the captcha. The advertisement 304 may include an advertisement message such as the messages, “ACME Auto Seller,” “Best Deals in Bay Area,” and “1% down on new vans.” Although not necessary, a captcha may additionally include an embedded question such as the embedded question 306, “Who has the best deals in the Bay Area?”, in captcha 302 illustrated in FIG. 3. Such an embedded question may be used together with a dialog window presented to a user prompting input of a response to the embedded question that may be verified against an answer 236 such as an answer stored with the question in a document 232 illustrated in FIG. 2. Just as there may be several advertisement messages included in an advertisement embedded in a captcha, there may be several questions embedded in the captcha about the advertisement. Other questions that may also be embedded in the captcha illustrated in FIG. 3 may include “What percent down on new vans?”, “Where is ACME Auto Seller located?”, and so forth. In various other embodiments, a question about the embedded advertisement may be presented as part of a dialog window displayed to a user to prompt input of a response to the question.

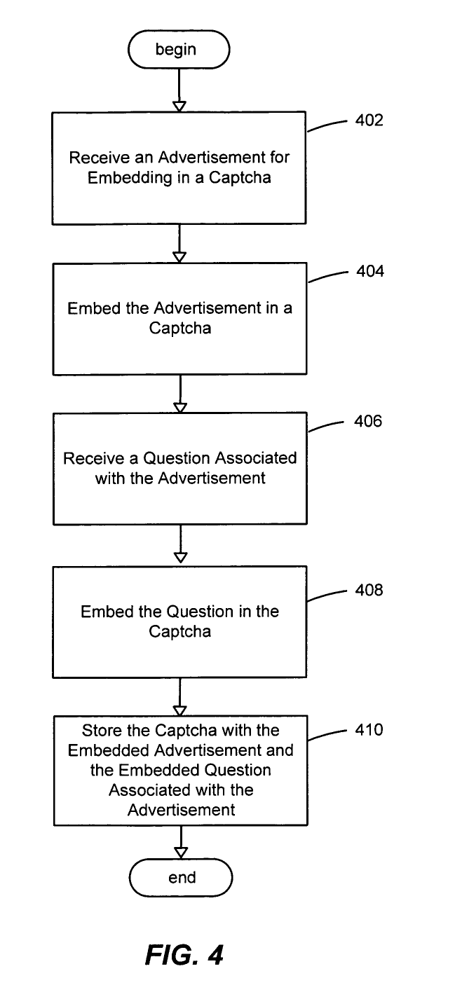

FIG. 4 presents a flowchart for generally representing the steps undertaken in one embodiment for generating a captcha with an embedded advertisement. An advertisement may be received for embedding in a captcha at step 402. The advertisement may be any type of advertisement or components of an advertisement including an image or text. The advertisement may be embedded in the captcha at step 404. In an embodiment, the advertisement may include text or an image presenting a message by pixels arranged into well-formed characters. (FIG. 3 includes the message “ACME Auto Seller”.) If the advertisement may include text, then the text may first be transformed into an image with pixels arranged into well-formed characters that represent the text. Then techniques may be used to distort the image, such as digital image warping techniques, to make the representation of text in the image unreadable by machine techniques, including optical character recognition techniques.

At step 406, a question associated with the advertisement may be received. In particular, the question may ask about information presented in a message included in the advertisement. For example, the question may be “Who has the best deals in the Bay Area?”. The question may be embedded in the captcha at step 408. In an embodiment, the question may first be transformed into an image with pixels arranged into well-formed characters that represent the text, and then the image may be distorted to make any representation of text in the image unreadable by machine techniques. The captcha with the embedded advertisement and the embedded question may be stored at step 410 and processing may be finished for generating a captcha with an embedded advertisement. In addition to storing the captcha with the embedded advertisement and the embedded question, the advertisement may be stored and a document with the question and an answer to the question may be stored as illustrated in FIG. 2. In an embodiment, the advertisement may be embedded into a captcha without embedding a question in the captcha. The question may instead be presented in a dialog to the user prompting a response to the question about the advertisement presented in the captcha. Executable or interpreted code for the dialog may be sent to the web browser along with the captcha with the embedded advertisement so that a dialog window may be displayed by the web browser prompting the user to input a response to the question about the advertisement presented in the captcha.

There may be many applications which may use the present invention for conveying marketing messages using captchas. Any applications which may require verification that a human being may be involved in a transaction or communication rather than an automated agent may use the present invention to generate and/or send a captcha with an embedded advertisement. For example, online applications for registering for an online account or for receiving comments may use the present invention. For any such applications, captchas with embedded advertisements may be used to verify a human being may be involved rather than an automated agent and furthermore may be advantageously used to deliver an online brand advertisement. Moreover, the present invention may also be used to verify that an impression of the marketing message has been received by a human being.

### Delivering Online Advertisements Using Captchas

The present invention is also generally directed towards a system and method for delivering online advertisements using a captcha with an embedded advertisement. In an embodiment, delivering marketing messages using captchas may be offered as service to Internet web sites. Such as service may generate advertisements for web sites and verify responses.

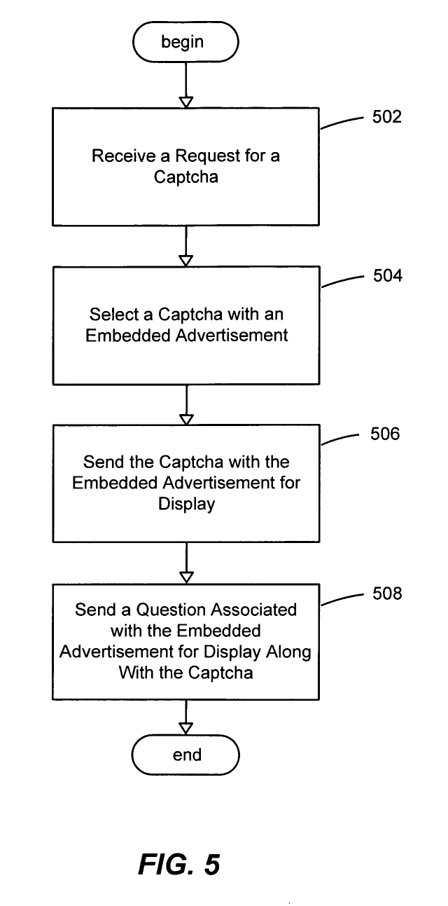

FIG. 5 presents a flowchart for generally representing the steps undertaken in one embodiment for delivering an online advertisement using a captcha with an embedded advertisement. A request for a captcha may be received at step 502. For instance, a request may be received by a web page server to serve a web page that may include a web page placement for a captcha with an embedded advertisement. The web page server may then request a captcha with an embedded advertisement from a captcha advertisement server to send to a web browser operating on a client so that the captcha with the embedded advertisement may be displayed as part of the web page on a client browser. At step 504, a captcha with an embedded advertisement may be selected. In various embodiments, a request for a captcha may also include a target ID for referencing a target or group of visitors that may be defined by a profile of characteristics that may match a visitor of the web page. For example, a profile may use characteristics such as demographic information including gender, age, or surfing behavior. In an embodiment, the captcha selector, described in conjunction with FIG. 2, may select a captcha with an embedded advertisement that may be associated with the target ID.

Upon selecting a captcha with an embedded advertisement, the captcha with the embedded advertisement may be sent at step 506 to a web browser operating on a client so that the captcha with the embedded advertisement may be displayed as part of the web page on a client browser. In some embodiments, a question about the advertisement may also be embedded into a captcha that may be displayed. In these embodiments, executable or interpreted code for a dialog may be sent to the web browser so that a dialog window may be displayed by the web browser prompting the user to input a response to the question about the advertisement presented in the captcha. In various other embodiments where the advertisement may be embedded into a captcha without embedding a question in the captcha, a question about the embedded advertisement may also be sent at step 508 for display. In such embodiments, executable or interpreted code for the dialog may be sent to the web browser along with the question so that the question may be presented in a dialog to the user prompting a response to the question about the advertisement presented in the captcha. After sending the captcha with the embedded advertisement and a question about the embedded advertisement, processing may be finished for delivering an online advertisement using a captcha with an embedded advertisement.

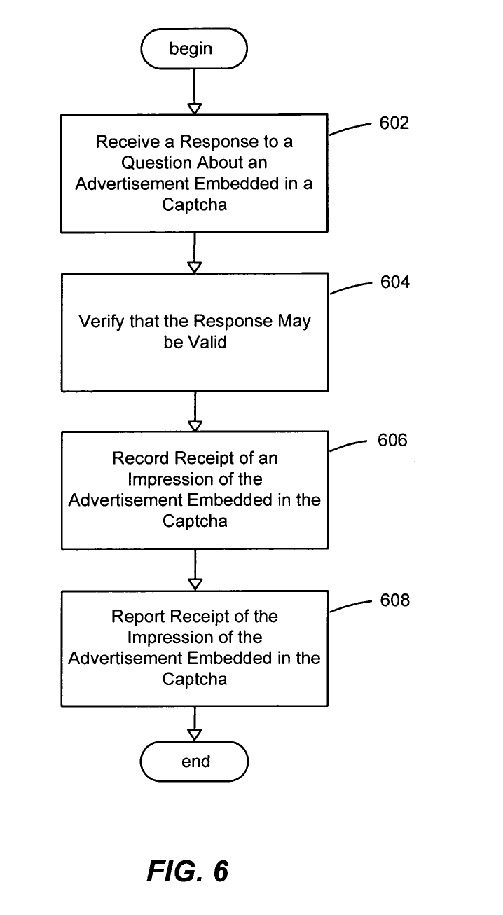

Additionally, verification of receipt of an impression may be provided using a captcha with an embedded advertisement to deliver an online advertisement. FIG. 6 presents a flowchart for generally representing the steps undertaken in one embodiment for verifying receipt of an impression of an online advertisement delivered using a captcha with an embedded advertisement. A response to a question about an advertisement embedded in a captcha may be received at step 602. In an embodiment, a response may be received from a user prompted to answer a question about an advertisement embedded in a captcha displayed as part of a web page by a web browser operating on a client. At step 604, the response may be verified to be valid. In an embodiment, a response validator operating on a captcha advertising server may verify that a response to a question about the advertisement embedded in the captcha may be valid by comparing the answer to the question with a valid response stored in a document that may include the question about the advertisement and the answer that may be a valid response to the question. At step 606, receipt of an impression of the advertisement embedded in a captcha may be recorded, for instance, in a measurements file. Additionally, receipt of an impression of the advertisement embedded in a captcha may be reported at step 608 to an advertiser and processing may be finished for verifying receipt of an impression of an online advertisement delivered using a captcha with an embedded advertisement.

### Measuring Awareness of Online Advertising Using Captchas

The present invention is also generally directed towards a system and method for measuring the awareness of an online advertisement delivered using a captcha with an embedded advertisement. In general, the members of a particular target audience may be segmented into two groups. An advertising campaign may be applied to members of one of the groups by sending a captcha with an embedded advertisement or an embedded poll. The members of the other group may not be exposed to the advertising campaign and may not be sent captchas with the embedded advertisement or embedded poll. Thus the members of a target audience may belong to one of two groups: those exposed to the advertising campaign and those not exposed to the advertising campaign. The effectiveness of the advertising campaign may then be measured by comparing awareness measures for the two groups of the target audience.

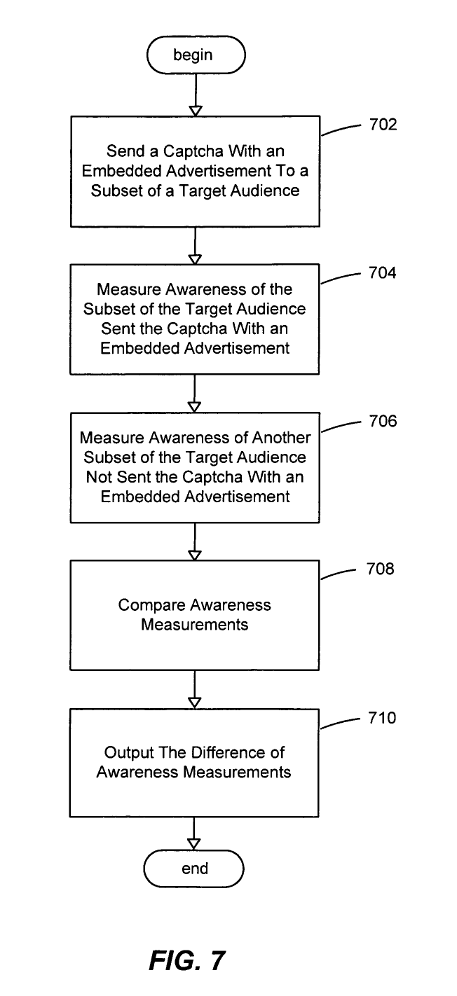

FIG. 7 presents a flowchart for generally representing the steps undertaken in one embodiment for measuring the awareness of an online advertisement delivered using a captcha with an embedded advertisement. In general, a target audience of visitors that may be identified offline may be divided into a subset that may be sent an online advertisement using a captcha with an embedded advertisement and a subset that may not be sent the captcha with the embedded advertisement. At step 702, a captcha with an embedded advertisement may be sent individually when requested to a web browser operating on a client for a subset of a target audience so that the captcha with the embedded advertisement may be displayed as part of a web page on the client browsers. In an embodiment, when a captcha may be requested to be sent to a web browser of a member of the target audience, a captcha may be selected and an indication may be recorded that the selected captcha was sent to the member of the target audience. At step 704, the awareness of the advertisement embedded in the captcha may be measured for the subset of the target audience sent the captcha. In various embodiments, the visitors of the web page to whom the captcha with the embedded advertisement was displayed may be polled after a particular time period. In some embodiments, a question about the advertisement may be sent to the web browsers of visitors prompting a visitor to input a response to the question about the advertisement embedded in the captcha. The responses to a question about the advertisement embedded in the captcha may be verified by comparing the answers to the question with a valid response that may be stored in a document that may include the question about the advertisement and the answer that may be a valid response to the question. For a verified response, receipt of an impression of the advertisement embedded in a captcha may be recorded, for instance, in a measurements file.

At step 706, the awareness of the advertisement embedded in the captcha may be measured for the subset of the target audience not sent the captcha. In various embodiments, the subset of the target audience not sent the captcha with the embedded advertisement may be polled during the same time period when the subset of the target audience sent the captcha with the embedded advertisement may be polled. After the awareness of the advertisement embedded in the captcha may be measured for both subsets of the target audience, the awareness measurements of the subset of the target audience sent the captcha may be compared at step 708 with the awareness measurements of the subset of the target audience not sent the captcha with the embedded advertisement. The difference between the awareness measurements of the two subsets may be output at step 710 and processing may be finished for measuring the awareness of delivering an online advertisement using a captcha with an embedded advertisement. In an embodiment, the difference between the awareness measurements of the two subsets may be output by reporting the difference between the awareness measurements of the two subsets to an advertiser.

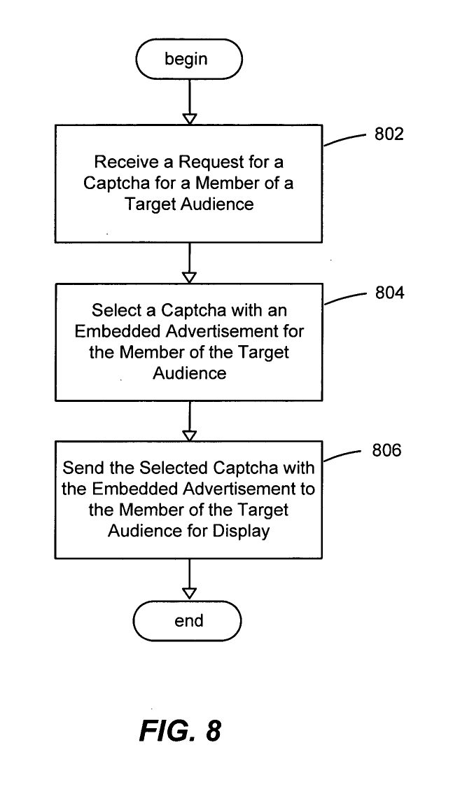

FIG. 8 presents a flowchart for generally representing the steps undertaken in one embodiment for delivering an online advertisement using a captcha with an embedded advertisement to a subset of a target audience. At step 802, a request for a captcha with an embedded advertisement may be received for a member of a subset of a target audience. A captcha with an embedded advertisement may be selected at step 804 to send to the member of the subset of the target audience. At step 806, the selected captcha with the embedded advertisement may be sent to the member of the subset of the target audience and processing may be finished for delivering an online advertisement using a captcha with an embedded advertisement to a subset of a target audience.

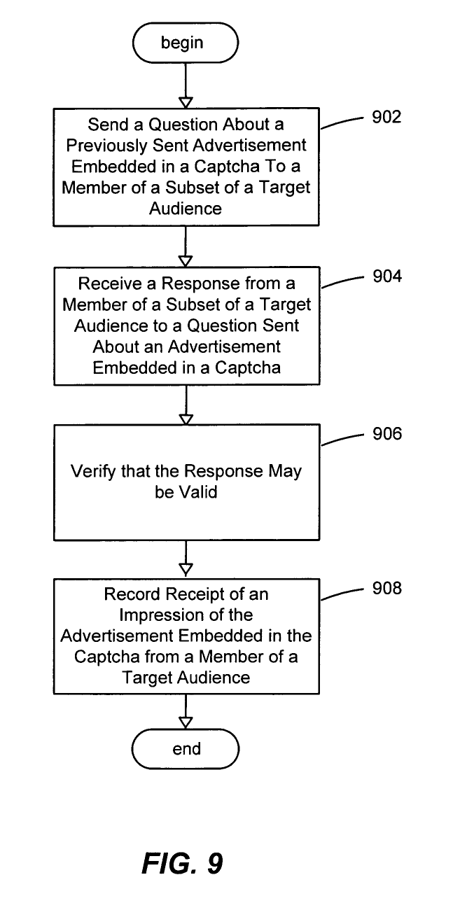

FIG. 9 presents a flowchart for generally representing the steps undertaken in one embodiment for verifying receipt of an impression of an online advertisement delivered using a captcha with an embedded advertisement to a subset of a target audience. At step 902, a question about a previously sent advertisement embedded in a captcha may be sent to a member of a subset of a target audience. A response to the question about a previously sent advertisement embedded in a captcha may be received at step 904 from a member of a subset of a target audience. A response to a question about the advertisement embedded in the captcha may be verified at step 906 by comparing the answer to the question with a valid response that may be stored in a document that may include the question about the advertisement and the answer that may be a valid response to the question. At step 908, receipt of an impression of the advertisement embedded in a captcha may be recorded for a verified response from a member of a subset of a target audience, for instance, in a measurements file.

Thus, the present invention may use responses to polls to develop evidence of the effectiveness of awareness advertising. The results of these responses might be collected into a whitepaper or other document in an embodiment and shared with advertisers to make the case for the return on investment of an awareness advertising campaign. In an alternate embodiment, the same system may be deployed as an in-the-loop measurement system that would provide results of responses directly to advertisers for indicating how their campaigns may impact brand awareness over time. In various embodiments, the effectiveness of a particular campaign may be measured relative to other advertising campaigns, or relative to modifications of the advertising campaign.

As can be seen from the foregoing detailed description, the present invention provides an improved system and method for providing and using captchas for online advertising. Such a system and method may efficiently be used to verify that a user has received an online brand advertisement and may also be used to measure the awareness of an online advertisement for a target audience. The system and method may apply broadly to online advertising campaigns, for example, to deliver online brand advertisements and measure effectiveness of the advertising campaign for increasing brand awareness. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for online advertising, comprising:
a captcha generator for creating a captcha with an embedded advertisement; and
a storage operably coupled to the captcha generator for storing the captcha with the embedded advertisement.

2. The system of claim 1 further comprising a captcha advertising server operably coupled to the storage for providing services for using the captcha with the embedded advertisement for online advertising.

3. The system of claim 1 further comprising the captcha with the embedded advertisement stored in the storage.

4. The system of claim 3 wherein the captcha with the embedded advertisement stored in the storage comprises the captcha with an embedded question about the embedded advertisement.

5. A computer-readable medium having computer-executable components comprising the system of claim 1.

6. A computer-implemented method for online advertising, comprising:
receiving an advertisement for embedding in a captcha;
embedding the advertisement in the captcha; and
storing the captcha with the embedded advertisement in storage for use in online advertising.

7. The method of claim 6 further comprising receiving a question about the advertisement.

8. The method of claim 7 further comprising embedding the question in the captcha with the embedded advertisement.

9. The method of claim 7 further comprising storing the question in storage for use with the captcha with the embedded advertisement in online advertising.

10. The method of claim 6 further comprising sending the captcha with the embedded advertisement for display as part of a web page.

11. The method of claim 6 further comprising displaying the captcha with the embedded advertisement as part of a web page.

12. The method of claim 6 further comprising receiving a target identification associated with the advertisement, the target identification referencing a group of visitors defined by a profile of characteristics.

13. The method of claim 12 wherein storing the captcha with the embedded advertisement in storage for use in online advertising comprises storing a captcha identification associated with the target identification in storage, the captcha identification referencing the captcha with the embedded advertisement.

14. The method of claim 9 wherein storing the question in storage for use with the captcha with the embedded advertisement in online advertising comprises storing a document identification associated with a captcha identification in storage, the document identification referencing a file including the question and the captcha identification referencing the captcha with the embedded advertisement.

15. The method of claim 7 further comprising:
receiving an answer to the question about the advertisement; and
storing the answer in storage for use in verifying a response to the question.

16. A computer-readable medium having computer-executable instructions for performing the method of claim 6.

17. A computer system for online advertising, comprising:
means for receiving an advertisement for embedding in a captcha;
means for creating the captcha with the embedded advertisement; and
means for displaying the captcha with the embedded advertisement as part of a web page.

18. The computer system of claim 17 further comprising:
means for receiving a question about the advertisement; and
means for embedding the question in the captcha with the embedded advertisement.

19. The computer system of claim 17 further comprising:
means for receiving a question about the advertisement; and
means for storing the question in storage for use with the captcha with the embedded advertisement in online advertising.

20. The computer system of claim 17 further comprising means for sending the captcha with the embedded advertisement for display as part of a web page.
